(19) United States
(12) Patent Application Publication
(10) Pub. No.: US 2013/0240771 A1
(43) Pub. Date: Sep. 19, 2013

(54) BALL VALVE WITH INTEGRATED FUGITIVE EMISSION ASSEMBLY

(71) Applicant: Amir Nemenoff, Karkom (IL)

(72) Inventor: Amir Nemenoff, Karkom (IL)

(73) Assignee: Flo-Rite Products Company, LLC, Vancouver, WA (US)

(21) Appl. No.: 13/488,922

(22) Filed: Jun. 5, 2012

Related U.S. Application Data
(60) Provisional application No. 61/611,699, filed on Mar. 16, 2012.

(51) Int. Cl. F16K 5/00

(52) U.S. Cl. 251/315.01; 251/356

(57) ABSTRACT

A valve includes a body that has an inner cavity configured to house a ball. The ball has a hole that allows fluid to pass through the inner cavity when the hole is aligned with a longitudinal axis of the cavity and prevents the fluid to pass through the inner cavity when the hole is misaligned with the longitudinal axis of the cavity. The valve includes a fugitive emission assembly that is integral to or a unitary part of the body.

### RELATED APPLICATION

This application claims the benefit of U.S. Provisional Application No. 61/611,699, filed Mar. 16, 2012, which is incorporated herein by reference in its entirety.

### BACKGROUND

1. Technical Field

The present disclosure relates generally to valves, and more particularly to valves having a body with an integrated fugitive emission assembly.

2. Related Art

Valves, such as ball valves, are devices that may be used to control fluid flow. Valves may be opened or closed to control flow. In some situations, undesirable media may become trapped inside the valve. To monitor or remove the undesirable media, valves may require an extension bonnet that facilitates emissions. The extension bonnet may be attached to a body of the valve through which the fluid may flow.

### SUMMARY

The present disclosure describes a valve that may include a body having a cavity that is configured to pass a fluid there-through. The valve may include a fugitive emission assembly that facilitates the flow of media from the valve. The fugitive emission assembly may comprise a unitary part of the body.

The present disclosure also describes a valve that may include a body having an inner cavity and a ball-like element movably disposed within the inner cavity. The ball-like element may be movable between an open position that allows fluid to flow through the inner cavity and a closed position that prevents the fluid from flowing through the inner cavity. The valve may include a fugitive emission assembly that facilitates the flow of media from the valve. The fugitive emission assembly may comprise an integral component of the body.

### BRIEF DESCRIPTION OF THE DRAWINGS

FIG. 1 is an exploded perspective view of a valve having an integrated fugitive emission assembly.

FIG. 2 is a cross-sectional side view of a valve having an integrated fugitive emission assembly.

FIG. 3 is a perspective view of a valve that includes a non-tamper proof locking assembly.

FIG. 4 is a perspective view of a valve engaged with a tamper-proof locking assembly, where the locking assembly is in an engaged and locked configuration and a handle is in a first position.

FIG. 5 is a perspective view of the valve shown in FIG. 4, where the locking assembly is in a disengaged configuration and the handle is in the first position.

FIG. 6 is a perspective view of the valve shown in FIGS. 4 and 5, where the locking assembly is in a disengaged configuration and the handle is in a second position.

FIG. 7 is a perspective view of the valve shown in FIG. 6, where the locking assembly is in an engaged and locked configuration and the handle is in the second position.

FIG. 8 is a cross-sectional side view of a valve, showing a locking stem and a spring of the tamper-proof locking assembly, where the locking assembly is in an engaged configuration.

FIG. 9 is a cross-section side view of the valve shown in FIG. 8, where the locking assembly is in an unengaged configuration.

FIG. 10 is a perspective underside view of a handle of a valve.

FIG. 11 is a perspective topside view of the handle shown in FIG. 10.

### DETAILED DESCRIPTION OF THE PREFERRED EMBODIMENTS

The present disclosure describes a valve having a body that may include an emissions portion, such as a fugitive emission assembly that is a unitary part or integrated with the body. Some valves have fugitive emission purge capability without requiring an extra device to purge the valve, like as an extension bonnet having emission ports. Some extension valves are attached to the body.

Some valves have a tamper-proof locking assembly. The locking assembly may lock or secure the valve in an open position or a closed position that control the flow of fluid through the valve. The locking assembly may be tamper-resistant to ensure the valve does not change state without proper access and/or authority.

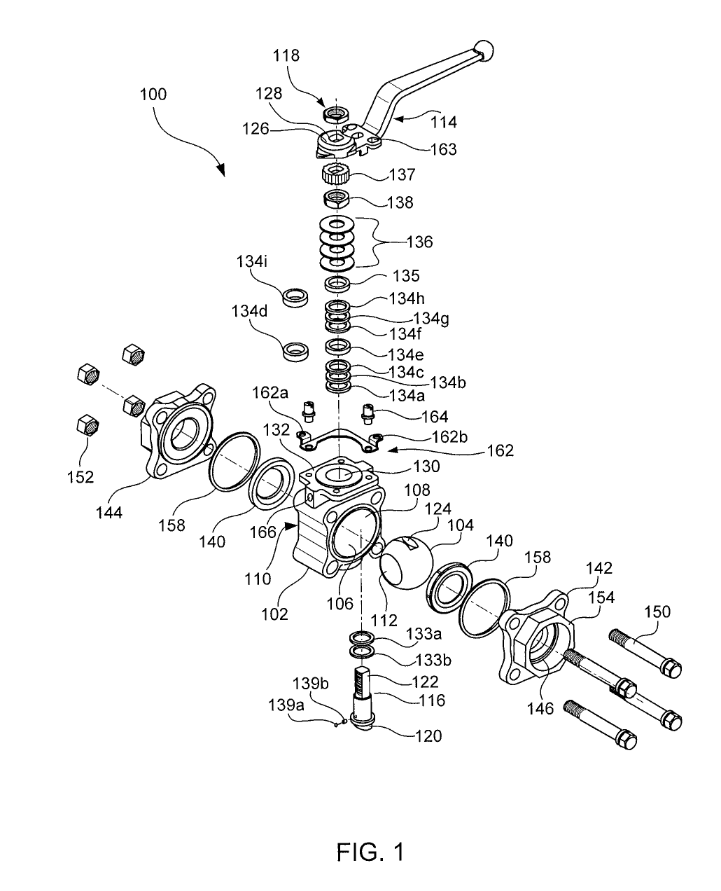

FIG. 1 is an exploded perspective view of a valve or valve assembly 100. The valve 100 may be a ball valve. As shown in FIG. 1, the valve 100 may include a body 102. The body 102 may be made of steel, such as stainless steel or carbon steel, or other metal alloys, as examples. The body 102 may surround a cavity 106 in which a medium, such as fluid or gas, may pass through. The cavity 106 may extend from a first end or opening 108 to a second end or opening 110 of the body 102. The cavity 102 may house a rounded movable object or ball 104 (collectively referred to as a ball) that may facilitate and/or control the flow of fluid through the cavity 106. The medium may or may not pass through the cavity 106 depending on the positioning or configuration of the ball 104.

The ball 104 may include a channel or passage 112 that extends through the ball 104 terminating between an inlet and outlet. The ball 104 may move in the cavity 106 between a first or open position and a second or closed position. When the ball 104 is in the open position, the channel 112 through the ball 104 may be substantially aligned with a longitudinal axis passing through the cavity 106, which allows fluid flow through the valve 102. When the ball is in a closed position, the channel 112 passing through the ball 104 may be substantially perpendicular or non-coincident to the longitudinal axis of the cavity 106, which may prevent fluid flow through the valve 102.

The valve 100 may include a handle 114 that couples the ball 104. The handle 114 may move between a first position and a second position. In some configurations, the first and second positions may be determined from a direction in which the handle 114 extends relative to the longitudinal axis of the cavity 106. When the handle 114 is in the first position, the ball 104 may be in either the open position or the closed position. When the handle 114 is in the second position, the ball 104 may be in the other of the open and the closed position.

The valve 100 may further include a valve stem assembly that may couple the handle 114 to the ball 104. The valve stem assembly may include a valve stem 116. The valve stern 116 may include a securing element 118 such as a handle nut that may secure the handle 114 to the valve stem 116. To couple the handle 114 to the ball, the valve stem 116 may include opposing ends 120, 122 that are each coupled to one of the ball 104 and the handle 114. For example, a first end 120 of the valve stem 116 may couple the ball 104, to engage with a slot or notch 124 in the ball 104. Additionally, an opposing second end 122 may couple the handle 114 at a coupling portion 126 of the handle 114. In one configuration, the coupling portion 126 may include an opening 128 configured to receive the second end 122. The second end 122 may extend through the opening 128 and engage with the securing element 118. In another configuration, where the securing element 118 includes a handle nut, the second end 122 may have a threaded configuration to engage with the handle nut. In order for the valve stem 116 to couple both the ball 104 and the handle 114, the body 102 may include a hole or inner chamber 130 that is large enough for at least a portion of the valve stem 116 to extend through and/or be disposed within. The inner chamber 130 may extend from the cavity 106 to a surface 132 of the body 102 that faces the coupling portion 126 of the handle 114. The valve stem 116 may extend from the ball 104, through the inner chamber 130 to the coupling portion 126. The inner chamber 130 in the body 102 may be configured so that the valve stem 116 may extend from the ball 104 to the handle 114 in a direction that is perpendicular or substantially perpendicular to the longitudinal axis passing through the cavity 106.

When coupled to the ball 104, axial or rotational movement of the valve stem 116 may move the ball 104 between an open and the closed positions. When the securing element 118 is engaged with the second end 122 in a secure or tightened position, the handle 114 may be coupled to the valve stem 116. When the valve stem 116 and the handle 114 are coupled together, movement of the handle 114 between the first and second positions may axially or rotationally move the valve stem 116. When the valve stem 116 is coupled to both the handle 114 and the ball 104, then movement of the handle 114 between the first and second positions may move the ball 104 between the open and closed positions. To enhance and/or facilitate the axial or rotational movement of the valve stem 116, one or more ring-shaped thrust bearings 133, such as a top thrust bearing 133a and a bottom thrust bearing 133b, may be disposed over, around, and/or about the valve stem 116. The thrust bearings 133 may be disposed at and/or near the first end 120 of the valve stem 116. The thrust bearings 133 may reduce friction generated between the valve stem 116 and a shoulder within the inner chamber 130 on which the valve stem 116, may rest, which may enhance and/or facilitate the rotational and/or axial movement of the valve stem 116.

The valve 100 may include valve stem packing 134 that may be disposed over, around, and/or about at least a portion of the valve stem 116 between first and second ends 120, 122. At least a portion of the valve stem packing 134 may separate and/or isolate the valve stem 116 from a side wall of the body 102 that forms the inner chamber 130. The valve stem packing may also provide a seal between the cavity 106 and the surface 132. The valve stem packing 134 may include a plurality of rings or ring-like structures 134a-i. In some example configurations, one or more of the rings, such as rings 134d, 134i, may be made of graphite for fire safety or prevention, as an example.

Additionally, one of the rings, such as ring 134e, may have one or more holes radially extending through the ring, for example between the inner and outer walls of the ring. In some configurations, the ring 134e having the holes may be a lantern ring. The holes of the ring 134e may align with emission holes 166 that extend within the body 102 to purge and/or remove undesirable media within the inner chamber 130, as described in more detail below.

The valve 100 may include at least one gland or gland ring 135 that may be disposed over, around, and/or about the valve stem 116. Additionally, the gland ring 135 may be disposed adjacent the valve stem packing 134, in direct contact with (e.g., directly above) the valve stem packing 134, and/or in between the valve stem packing 134 and the coupling portion 126 of the handle 114. The gland ring 135 may compress the valve stem packing 134 and/or compress the individual rings 134a-i together. Additionally, the gland ring 135 may align and/or maintain positioning of the valve stem 116 in its axial position within the inner chamber 130. The gland ring 135 may prevent the valve stem 130 from being pulled off-axis or “sideways,” which may be referred to as “side loading.”

In addition, the valve 100 may include one or more elements to relieve friction, prevent leakage, and/or distribute pressure. In some devices flat disks or washers 136, such as Belleville washers or conical spring washers, that may be disposed over, around, and/or about the valve stem 116. The washers 136 may be disposed adjacent the gland ring 135, in direct contact with (e.g., directly above) the gland ring 135, and/or in between the gland ring 135 and the coupling portion 126 of the handle 114. The washers 136 may provide resiliency for sealing made by the stem packing 134 as the valve 100 is subjected to various environmental conditions, such as temperature, pressure, and erosion. The washers 136 may provide a constant load on the stem packing 134, which may be referred to as live-loaded stem packing.

The valve 100 may further include securing mechanisms in addition to the securing mechanism 118, to attach and/or secure the coupling portion 126 of the handle 114 to the valve stem 116. The additional securing mechanisms may include a lock tab 137 and/or a packing nut 138. The lock tab 137 and/or the packing nut 138 may be disposed over, around, and/or about the valve stem 116. The lock tab 137 and/or the packing nut 138 may be coupled to the coupling portion 126 at a side opposite a side that the securing mechanism 118 is coupled to the coupling portion 126. Additionally, the lock tab 137 and/or the packing nut 138 may be disposed in between the washers 136 and the coupling portion 126 of the handle 114. The lock tab 137 and/or the packing nut 138 may provide a more secure and/or stable connection between the handle 114 and the valve stem 116 than if handle 114 was in direct contact with the washers 136.

The valve 100 may also include anti-static elements 139, including an anti-static ball 139a and an anti-static spring 138b. In some systems, the anti-static elements 139 may couple the valve stem 116 at and/or near the first end 120. The anti-static elements 139 may remove and/or discharge electric charge, such as static electric charge, that has accumulated within and/or on the valve 100. In some systems, the anti-static elements 139 may be part of a conducting path to a ground (being part of a safety device). For example, the static elements may form part of a discharge or ground path. By discharging or grounding the electric charge, the anti-static elements 139 may prevent arcing or sparking that may occur when the valve 100 accumulates electrical charge.

Some valves 100 include one or more components 140 that may position and/or secure the ball 104 within the cavity 106, facilitate movement of the ball 104, and/or provide tracking for the ball 104 when the ball 104 moves between the open and closed positions. The components 140 may be disposed within the cavity 106 and include seats or other ring-like structures that are sized and/or dimensioned in accordance with the size or dimensions of the ball 104.

The valve 100 may also include end caps 142, 144 that attach to the body 102 at the first and second ends 108, 110. Each of the end caps 142, 144 may include an opening 146, 148 in which fluid may pass. The openings 146, 148 may be sized proportionally and/or in accordance with the cavity 106. The end caps 142, 144 may be attached to the body 102 so that the openings 146, 148 of the end caps 142, 144 are substantially aligned and/or concentric with first and second openings 108, 110 of the body 102. The end caps 142, 144 may be attached to the body using fasteners such as bolts 150 and nuts 152. In operation, one of the openings 146, 148 may receive fluid and pass fluid through the cavity 106 to the other opening 146, 148, where the fluid exits the valve 100. In addition, each of the end caps 142, 144 may include connecting portions 154, 156 that connect to a tubular member such as a pipe or a hose (not shown) that delivers the fluid to or and/or from the valve 100. The valve 100 may further include one or more ring-like body seals 158 that may be positioned around the first and second openings 108, 110 of the body 102. The seals 142 may prevent fluid that has entered the cavity 106 from exiting the valve 100 in between the body 102 and the end caps 142, 144.

In some configurations, the valve 100 may further include a lock plate 160 that is configured to be attached to the surface 132. The lock plate 160 may include locking portions 162a, 162b, such as holes that may extend away and/or protrude from the body 102. The lock plate 160 may be configured so that when the handle 114 is in the first position or the second position, one of the holes 162a, 162b may be in alignment with a portion, such as a hole 163, of the handle 114. The holes 162a, 162b may be aligned with a hole 163 of the handle 114 so that a lock or other device may engage with both the handle 114 and one of the holes 162a, 162b in order to prevent movement of the handle 114 relative to the body 102 and/or in order to prevent movement of the handle 114 between the first and second positions. Some valves 100 may use stop pins 164 to attach and/or secure the lock plate 160 to the body 102.

The valve 100 may also include an emission assembly, such as a fugitive emission assembly that substantially or completely detects, removes, and/or purges undesirable media (e.g., liquid, gas, dust, other media, etc.) from the valve 100. Some fugitive emission assemblies may include one or more emission outlets or ports 166 that may be shaped or described as openings, holes, or perforations. Some emission holes 166 may comprise an integral or unitary part of the body 102.

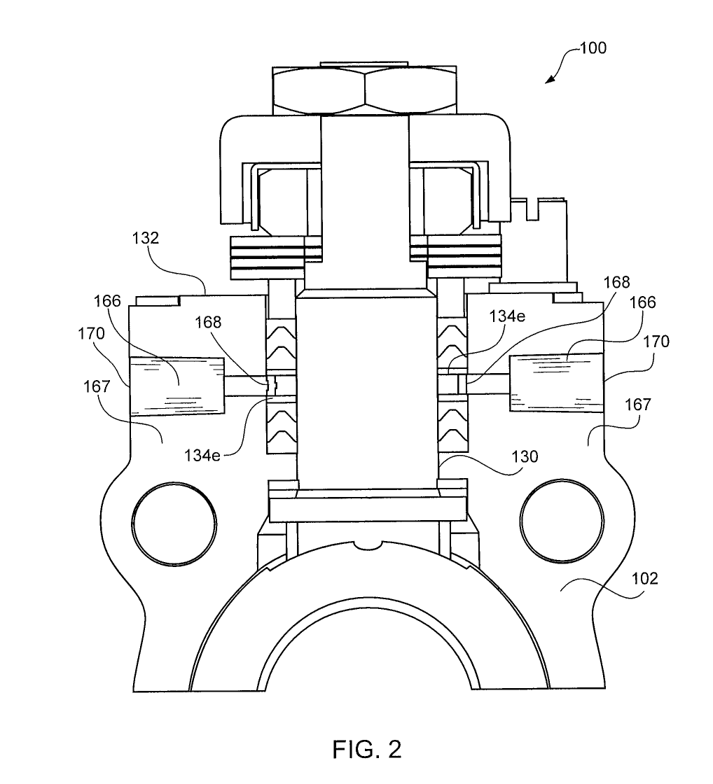

FIG. 2 shows a cross-sectional side view of the valve 100, shown along the longitudinal axis passing through the cavity 106. The emission holes 166 may be positioned and/or extend within the body 102. In some systems, the emission holes 166 may extend through a portion 167 of the body 102 in between the cavity 106 and the surface 132. Additionally, the emission holes 166 may extend in a direction that is perpendicular or substantially perpendicular to the direction in which the valve stem 116 extends through the inner chamber 130. Also, in some example configurations, some or all of the emission holes 166 may extend in the body 102 in a direction that is perpendicular or substantially perpendicular to the longitudinal axis passing through the cavity 106. In other example configurations, some or all of the emission holes 166 may extend in other directions, such as parallel to the longitudinal axis passing through the cavity 106 or in directions at angles other than perpendicular to or parallel with the longitudinal axis passing through the cavity 106. Various configurations or combinations of configurations are possible.

Some or all emission holes 166 may be in fluid communication with the inner chamber 130 of the body 102. In some example configurations, the fugitive emission assembly may include one or more emission holes, such as two emission holes, in fluid communication with the inner chamber 130. Where the configuration includes two emission holes 166, the two emission holes 166 may be positioned at opposing portions of the inner chamber 130. Each of the emission holes 166 may include an inner opening 168 that may face the valve stem 116 and/or a portion of the valve stem packing 134, such as the lantern ring 134e. The inner openings 168 may be in communication with the inner chamber 130 by each being in communication and/or aligned with one of the holes of the lantern ring 134e. Each of the emission holes 166 may also include an outer opening 170 opposite the inner opening 168 that faces the outside of the valve 100. Undesirable media contained within the chamber 130 may exit the chamber 130 through the holes of the lantern ring 134e. The undesirable media may then exit the body 102 of the valve 100 by passing through the inner and outer openings 168, 170 of the emission holes 166. By using one or more of the holes of the lantern ring 134e, the valve 100 may be configured so that a portion of the valve stem packing 134 disposed within the inner chamber 130, such as the lantern ring 134e, may also be a part of the emission assembly that removes undesirable media from the inner chamber 130 of the valve 100.

In some configurations, at least a portion of the outer openings 170 may be configured and/or adapted to connect to and/or couple to a device, such as a sniffer or a gauge, that may detect and/or monitor media, characteristics of the media, and/or environmental conditions within the valve 100 (e.g., pressure, temperature) at the outer openings 170. The outer openings may connect to the device by having a threaded configuration, as an example. When one or more devices are attached to the valve 100, such as at the outer openings 170, at least some media may be detected and/or purged from an interior portion of the valve 100, such as from the inner chamber 130, without the media escaping into an outer environment.

In addition, the valve 100 may include and/or be locked with a locking assembly. The locking assembly may be a mechanical or electromechanical device or structure that may prevent the handle 114 from moving or being moved between the first and second positions without proper access. Access may be provided through a device such as a key, software code (e.g., a digital certificate) or secure communication, or other devices or processes that provides access.

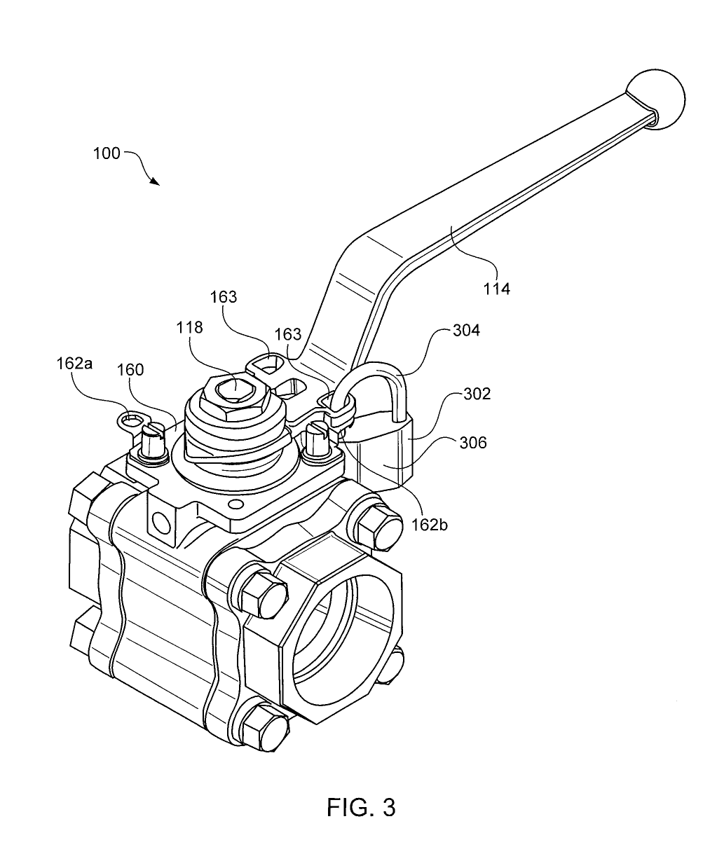

FIG. 3 is a perspective view of the valve 100 that includes and/or is engaged with a locking device 302 that prevents movement of the handle 114 between the first and second positions. The locking device 302 may include a portion 304, such as a U-shaped rod or bar, that may be inserted through a hole 163 of the handle 114 and one of the holes 162a, 162b of the lock plate 160. After the bar 304 is inserted through the hole 163 and one of the holes 162a, 162b, the bar 304 may engage with a locking portion 306 of the locking device 302 so that the locking device 302 is in a locked configuration. By engagement with both the handle 114 and the lock plate 160, and through the locked configuration, the locking device 302 may prevent movement of the handle 114 between the first and second positions, and as such, prevent the valve 100 from being opened and closed without proper access.

The locking device 302 alone may not be tamper-resistant because the ball 104 may be moved between the open and closed positions, even when the locking device 302 is locked and engaged with the valve 100, if the valve 100 is subjected to tampering. For example, in FIG. 3, the valve 100 may be tampered with by detaching the exposed securing mechanism 118 from the second end 122 of the valve stem 116. By detaching the securing mechanism 118, the handle 114 may be detached and/or decoupled from the valve stem 116, which may enable access and/or movement to the valve stem 116. In turn, the ball 104 may be moved between the open and closed positions without unlocking the locking device 302 and disengaging the locking device 302 from the handle 114 and/or the lock plate 160.

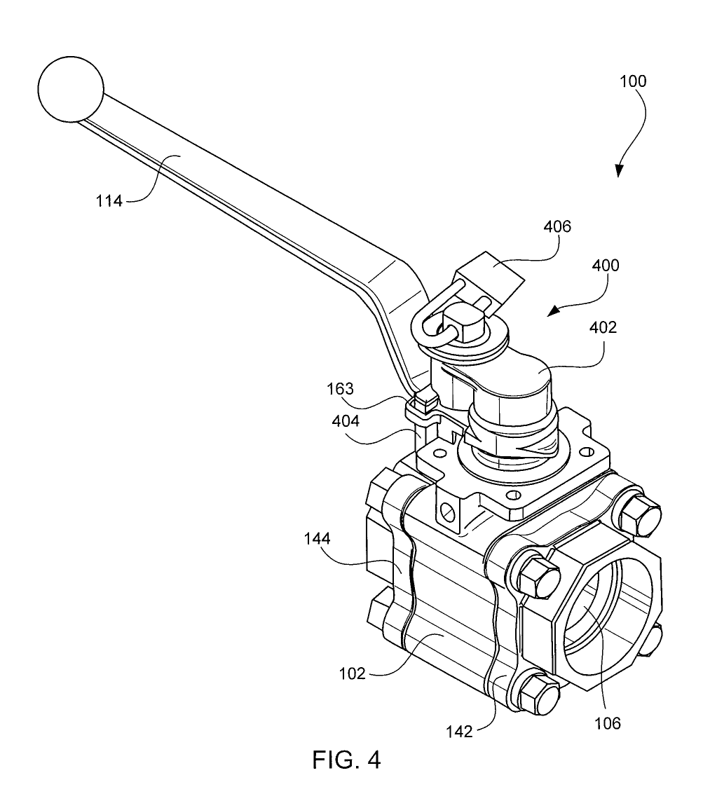

In addition and/or alternatively to being configured to include and/or engage with a non-tamper proof lock, the valve 100 may include and/or engage with a tamper-resistant or tamper-proof lock or tamper-proof locking assembly. FIG. 4 shows the valve 100 that includes and/or engages a tamper-proof locking assembly 400. The tamper-proof locking assembly 400 may include a cover 402 that covers at least a portion of and/or prevent access to the securing mechanism 118. The cover 402 may move between a covered position and an uncovered position. In the covered position, the cover 402 may cover and/or prevent access to the securing mechanism 118. In the uncovered position, the cover 402 may expose and/or provide access to the securing mechanism 118.

The tamper-proof locking assembly 400 may further include one or more stems or pins 404 that are configured to prevent movement of the handle 114 relative to the body 102 and/or prevent movement of the handle to move the ball 104 between the open and closed positions. The pins 404 may be movable between an inhibitive position and a non-inhibitive position. In the inhibitive position, the pins 404 may engage with the handle 114, such as by extending through the one or more holes 163 of the handle 114. The pins 404 may engage with the handle 114 and extend to a position adjacent the body 102 or one of the end caps 142, 144. When extended to the position adjacent the body 102 or one of the end caps 142, 144, at least a portion of the each of the pins 404 is adjacent to a portion of the body 102 or the end caps 142, 144. In the inhibitive position, the pins 404 may prevent or inhibit movement or rotation of the handle 114 relative to the body 102. In the non-inhibitive position, the pins 404 may be disengaged from the handle 114, in which the pins 404 may not extend through the holes 163 to a position adjacent the body 102 or one of the end caps 142, 144. In the non-inhibitive position, the pins 404 may be unable to prevent or inhibit movement of the handle 114 relative to the body 102, and the handle 114 may be free and/or uninhibited by the pins 404 to move between the first and second positions.

In some configurations, the pins 404 may be a unitary part of, integral with and/or attached to the cover 402. Unitary pins 404 integral with and/or attached to the cover 402, allows the tamper-proof locking assembly 400 to include a single component that covers the securing mechanism 118 and may prevent or inhibit the handle 114 from being moved to open and close the valve 100. When the cover 402 is in the covered position, the pins 404 may be in the inhibitive position. Alternatively, when the cover 402 is in the uncovered position, the pins 404 may be in the non-inhibitive position. In addition or alternatively, some valves 100 that include and/or engage the tamper-proof locking assembly 400 may not include and/or may not have attached to the body 102 the lock plate 160.

The tamper-proof locking assembly 400 may further include a lock-engaging member 404 that may engage with a locking device to lock and/or secure the cover 402 in the covered position and/or to prevent the cover 402 from being moved from the covered position to the uncovered position. In addition or alternatively, the lock-engaging member 404 may engage a locking device to lock and/or secure the pins 404 in the inhibitive position. To lock and/or secure the cover 402 in the covered position and/or the pins 404 in the inhibitive position, the lock-engaging member 404 may securely attach to a locking device 406. For example, the locking device 406 may be attached to the lock-engaging member 404, such as by having a U-shaped bar or rod that may be inserted through a hole in the lock-engaging member 404, and may be locked once attached to the lock-engaging member 404. In some configurations, the locking device 406 may be securely attached to the lock-engaging member 404 only when the cover 402 is in the covered position and/or only when the pins 404 are in the inhibitive position. When the locking device 406 is attached to the lock-engaging member 404 and locked, the locking assembly 400 may be in a locked position, such that the cover 402 may be prevented from moving to an uncovered position and the pins 404 may be prevented from moving to the non-inhibitive position without proper access to unlock the locking device 406 and detach the locking device 406 from the lock-engaging member 404.

The tamper-proof locking assembly 400 may be in at least three different states or configurations—an unengaged configuration, an engaged and unlocked configuration, and an engaged and locked configuration. In the unengaged configuration, the cover 402 may be in the uncovered position and the pins 404 may be in the inhibitive position, allowing the handle 114 to move between the first and second positions to open and close the valve 100. In the engaged and unlocked configuration, the cover 402 may be in the covered position and the pins 404 may be in the inhibitive position, inhibiting movement of the handle 114 between the first and second positions. Additionally, in the engaged and unlocked configuration, the locking device 406 may be unattached to, disengaged with, and/or unlocked with the lock-engaging member 404. As such, in the engaged and unlocked configuration, a user or operator, with or without authorized access to unlock the locking device, may change the configuration of the locking assembly 400 to the unengaged configuration to open and close the valve 100 because the locking device is unlocked and/or unattached to the lock-engaging member 404.

In the engaged and locked configuration, the cover 402 may be in the covered position and the pins 404 may be in the inhibitive position. Additionally, in the engaged and locked configuration, the locking device 406 may be attached to, engaged with, and locked with the lock-engaging member 404. As such, in the engaged and locked configuration, a user or operator of the valve 100 may change the configuration of the locking assembly 400 to the unengaged configuration to open and close the valve 100 only if the user or operator has authorized access, such as by having a key, to unlock and detach the locking device 406 from the lock-engaging member 404.

FIG. 4 shows the locking assembly 400 in the engaged and locked configuration. When the locking assembly is in the engaged and locked configuration, the handle 114 may be in either the first position or the second position. As previously described, the first and second positions may be defined and/or determined based on a direction in which the handle 114 extends relative to the longitudinal axis of the cavity 106. For example, the first position or the second position may be defined and/or determined as a position in which the handle 114 extends in a direction that is parallel or substantially parallel to the longitudinal axis of the cavity 106, as the handle 114 is shown in FIG. 4. Additionally, the other of the first position or the second position may be defined and/or determined as a position in which the handle 114 extends in a direction that is perpendicular or substantially perpendicular to the longitudinal axis of the cavity 106. Suppose for example, that the handle 114, extending parallel to the longitudinal axis of the cavity 106 as shown in FIG. 4, is in the first position. To move the handle 114 to the second position, the locking device 406 may be unlocked and removed from the lock-engaging member 404 so that the locking assembly 400 may be configured in the engaged and unlocked configuration. From the engaged and unlocked configuration, the locking assembly 400 may be moved to the unengaged configuration and the handle 114 may be rotated to the second position.

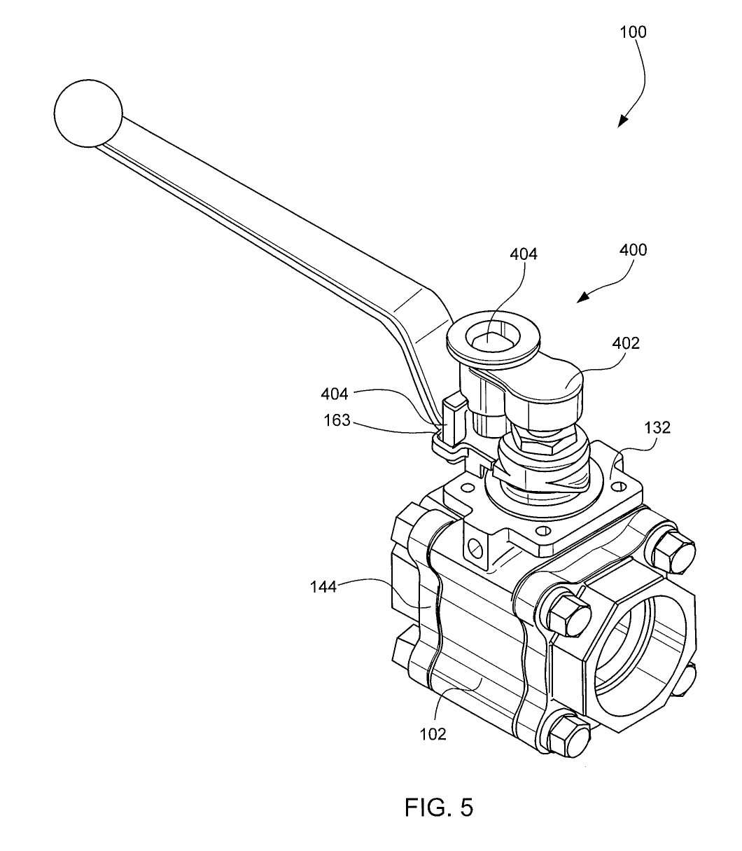

FIG. 5 shows the locking assembly 400 in the unengaged configuration. As shown in FIG. 5, when the locking assembly 400 is in the unengaged configuration, the cover 402 may be in the uncovered position and the pins 404 may be in the non-inhibitive position. When the pins 404 are in the non-inhibitive position, the pins 404 may be spaced away from the end cap 144 such that the pins 404 may be unable to inhibit movement of the handle 114 from the first position to the second position. Additionally, as shown in FIG. 5, when the pins 404 are in the non-inhibitive position, the pins 404 may extend at least partially in the holes 163 of the handle. In alternative configurations, when the pins 404 are in the non-inhibitive position, the pins 404 may not extend into and/or may be positioned away from the holes 163.

To move the locking assembly 400 from the engaged and unlocked configuration to the unengaged configuration, the cover 402 may be lifted or moved away from the body 102 in a direction in which the surface 132 faces. In some example configurations, when the locking assembly 400 is in the unengaged configuration and/or moved from the engaged and unlocked configuration to the unengaged configuration, at least a portion of the cover 402 may cover or shield at least a portion of the lock-engaging member 404, such as by surrounding the lock-engaging member 404. By covering and/or shielding the lock-engaging member 404, the locking device 406 may be prevented from being attached and/or secured to the lock-engaging member 404.

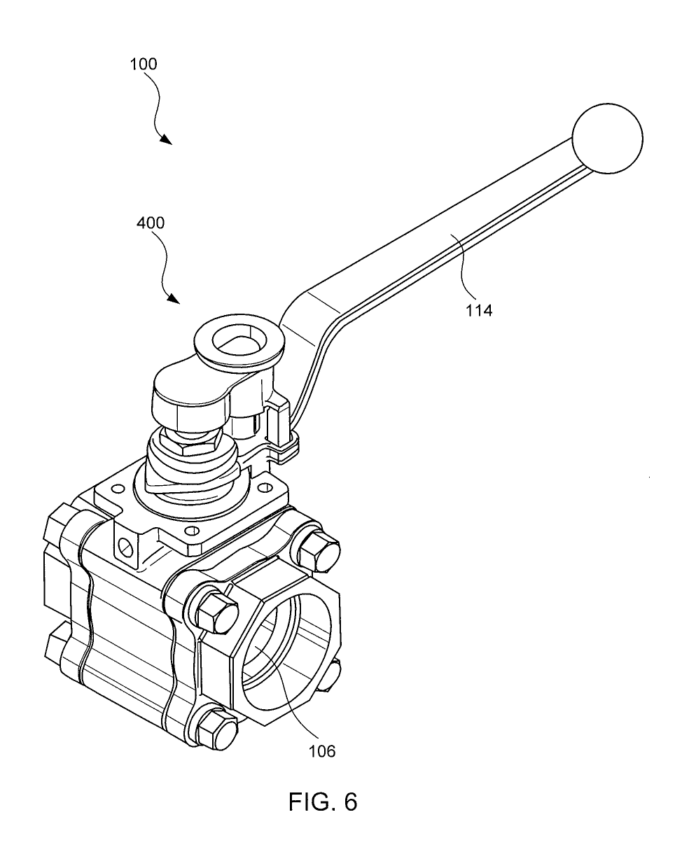

FIG. 6 shows the locking assembly 400 in the unengaged configuration and the handle 114 in the second position, where the second position is defined and/or determined as a position in which the handle 114 extends in a direction that is perpendicular or substantially perpendicular to the longitudinal axis of the cavity 106. By configuring the locking assembly 400 in the unengaged configuration as shown in FIG. 5, the handle 114 may be moved from the first position (shown in FIG. 5) to the second position as shown in FIG. 6.

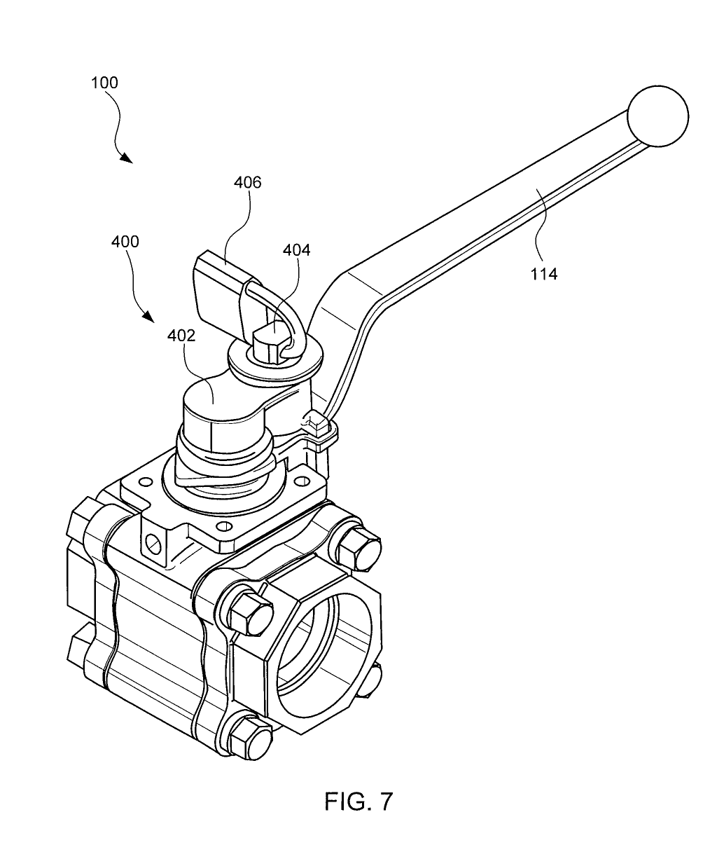

FIG. 7 shows the locking assembly 400 in the engaged and locked configuration and the handle 114 in the second position. The locking assembly 400 may be configured in the engaged and locked position when the handle 114 is in the second position by moving the locking assembly 400 from the unengaged position to the engaged and unlocked configuration when the handle 114 is in the second position. When the locking assembly 400 is in the engaged and unlocked configuration, the cover 402 may be in the covered position, which may expose, uncover, and/or un-shield the lock-engaging member 404, allowing the locking device 406 to be attached and locked to the lock-engaging member 404. When the locking device 406 is attached and locked to the lock-engaging member 404, the locking assembly may be configured in the engage and locked configuration.

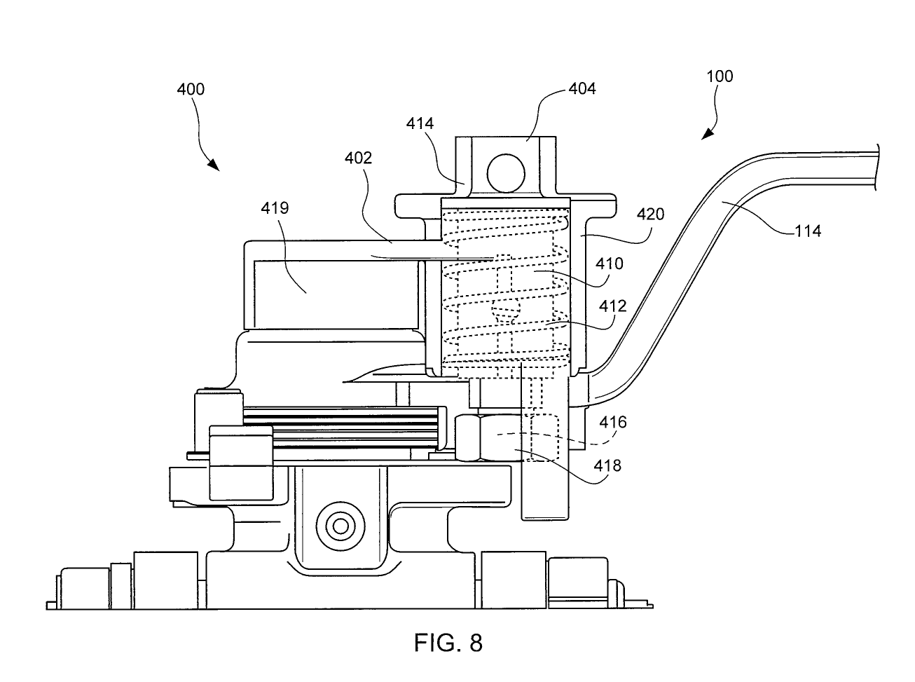

FIG. 8 shows a cross-sectional side view of the tamper-proof locking assembly 400, showing the tamper-proof locking assembly 400 in further detail. The locking assembly 400 may further include a locking stem 410 and an elastic device or biasing device, like a spring 412, disposed over, about, and/or around the locking stem 410. The locking stem 410 and/or the spring 412 may facilitate movement of the locking assembly 400 between the engaged and unengaged configurations. The locking stem 410 may have a first end 414 that includes the lock-engaging portion 404. A second opposing end 416 of the valve stem 410 may engage with and secured to the handle 114, such as by using a bolt 418.

In some configurations, the cover 402 may include a first portion 419 that is configured to cover the securing mechanism 118 (not shown in FIG. 8) and a second portion 420 that is configured to cover at least a portion of the locking stem 410 and/or a portion of the locking stem 410 that includes the spring 412.

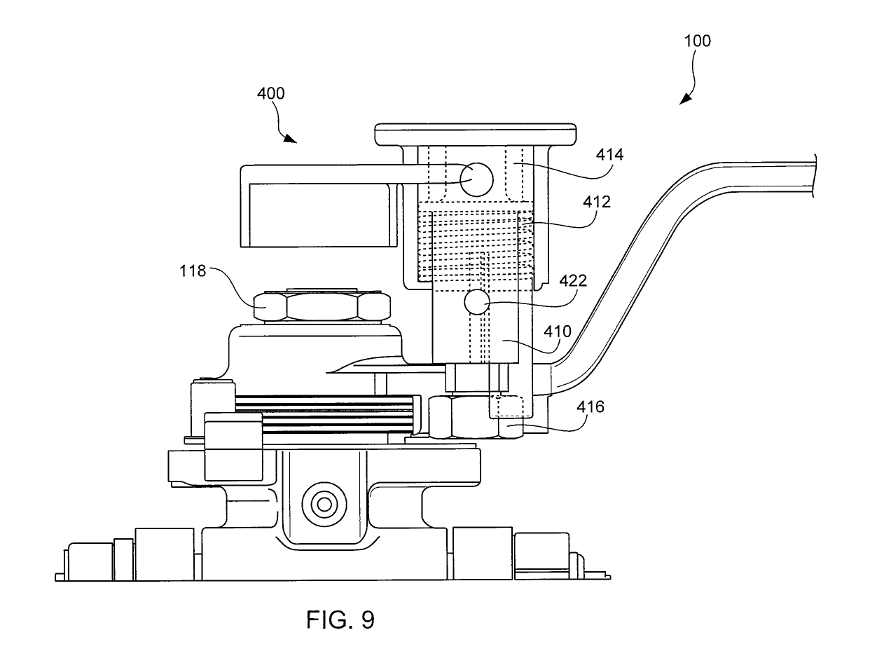

The spring 412 may be moved between an uncompressed position and a compressed position. As shown in FIG. 8, when the locking assembly 400 is in either the engaged and locked configuration or the engaged and unlocked configuration, the spring 412 may be in the uncompressed position. Alternatively, as shown in FIG. 9, when the locking assembly 400 is in the unengaged configuration, the spring 412 may be in the compressed position. To move the locking assembly 400 from the locked position to the unlocked position, a bias, such as an external bias, may be applied to and/or exerted on the locking assembly 400 to compress the spring 412. Alternatively, when no bias is applied to the locking assembly 400 to compress the spring 412, the locking assembly 400 may be in an engaged configuration. In some configurations, when bias is applied to the locking assembly 400 to compress the spring 412 and move the locking assembly 400 to the unengaged configuration, the bias may be removed and/or released from the locking assembly 400 to move the locking assembly 400 from the unengaged configuration to the engaged and unlocked configuration.

In some configurations, the locking stem 410 may include a hole 422 extending through the locking stem 410 at about midway between the first and second ends 418, 420 of the locking stem 410. The hole 422 may receive a pin or a rod that, when inserted into the hole 422, is configured to have at least one end that protrudes from the locking stem 410. When the pin is inserted into the hole 422, the pin may prevent the locking assembly 400 from moving from the unengaged configuration to the engaged and unlocked configuration when bias used to compress the spring 412 is released.

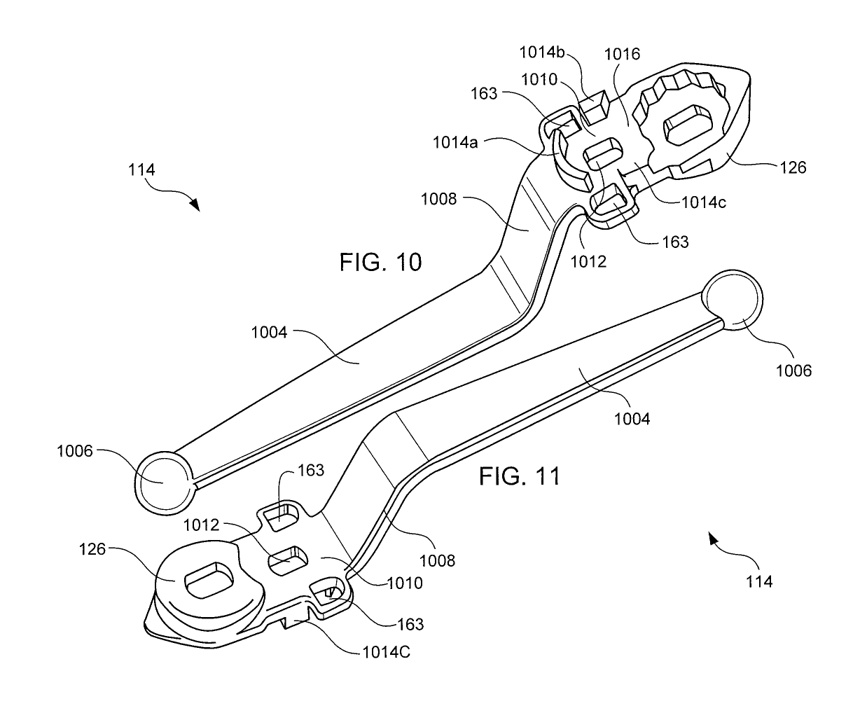

FIGS. 10 and 11 show perspective views of the handle 114. FIG. 10 shows a topside view of the handle 114. FIG. 11 shows an underside of the handle 114. The handle 114 may include a gripping portion 1004 that may provide an area of the handle 114 for an operator to hold or grip when rotating the handle 114 between the first position and the second position. An end portion 1006 of the gripping portion 1004 may include a rounded portion or a ball, which may prevent an operator from sliding off of the gripping portion 1004. The gripping portion 1004 may couple to a middle portion 1008, which may provide a transition from the gripping portion 1004 to a locking portion 1010.

The locking portion 1010 of the handle 114 may include one or more components or features that may be part of and/or engage with the tamper-proof locking assembly 400. For example, the locking portion 1010 may include the holes 163 that may each engage with and/or receive one of the pins 404 that inhibit movement of the handle 114 between the first and second positions. As shown in FIGS. 10 and 11, the holes 163 may be positioned in between the gripping portion 1010 and the coupling portion 126, which may couple the handle 114 to the valve stem 116. Additionally, the locking portion 1010 may include a hole 1012, which may be disposed in between or substantially in between two of the holes 163 configured to receive the pins 404. The hole 1012 may engage with and/or receive the second end 416 of the locking stem 410 (shown in FIGS. 8 and 9). Further, the locking portion 1010 may include one or more side walls or sidewall portions 1014 that extend and/or protrude from an undersurface 1016 of the handle 114. For example, as shown in FIGS. 10 and 11, the handle 114 may include three sidewall portions 1014a, 1014b, 1014c. The sidewall portions 1014 may shield, cover, and/or prevent access to the bolt 416 used to secure the locking stem 410 to the handle 114 and/or the securing mechanism 118. By shielding, covering, and preventing access to the bolt 416 and/or the securing mechanism 118 using the sidewall portions 1014, further tamper-proof capabilities of the locking assembly 400 and/or the valve 100 are provided.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A valve comprising:
a body comprising a cavity configured to pass a fluid there through; and
a fugitive emission assembly configured to allow the flow of media from the valve,
wherein the fugitive emission assembly comprises an integral component of the body.

2. The valve of claim 1, wherein the fugitive emission assembly comprises an emission hole extending within the body, the emission hole being in fluid communication with an inner chamber of the body.

3. The valve of claim 2, wherein the emission hole comprises a first emission hole, and wherein the fugitive emission assembly comprises a second emission hole extending within the body,
wherein the first and second emission holes are in fluid communication with the inner chamber at opposing portions of the inner chamber.

4. The valve of claim 2, wherein the emission hole extends within the body in a direction that is substantially perpendicular to a longitudinal axis of the cavity.

5. The valve of claim 2, wherein the valve further comprises:
a valve stem disposed within the inner chamber; and
valve stem packing disposed around the valve stem,
wherein the emission hole is configured to receive the media from an opening in the valve stem packing.

6. The valve stem of claim 5, wherein the valve stem packing comprises a lantern ring comprising the opening in the valve stem packing.

7. The valve stem of claim 5, wherein the opening in the valve stem packing is in alignment with an inner opening of emission hole.

8. A valve comprising:
a body having an inner cavity;
a ball-like element movably disposed within the inner cavity, the ball-like element being movable between an open position that allows fluid to flow through the inner cavity and a closed position that prevents the fluid from flowing through the inner cavity; and
a fugitive emission assembly configured to allow the flow of media from the valve, wherein the fugitive emission assembly comprises an integral component of the body.

9. The valve of claim 8, wherein the fugitive emission assembly comprises an emission hole extending within the body, the emission hole being in fluid communication with an inner chamber of the body.

10. The valve of claim 9, wherein the emission hole comprises a first emission hole, and wherein the fugitive emission assembly comprises a second emission hole extending within the body,
wherein the first and second emission holes are in fluid communication with the inner chamber at opposing portions of the inner chamber.

11. The valve of claim 9, wherein the emission hole extends within the body in a direction that is substantially perpendicular to a longitudinal axis of the cavity.

12. The valve of claim 9, wherein the valve further comprises:
a valve stem disposed within the inner chamber, the valve stem coupled to the ball-like element, wherein axial movement of the valve stem is configured to move the ball-like element between the open and closed positions; and
valve stem packing disposed around the valve stem,
wherein the emission hole is configured to receive the media from an opening in the valve stem packing.

13. The valve stem of claim 12, wherein the valve stem packing comprises a lantern ring comprising the opening in the valve stem packing.

14. The valve stem of claim 12, wherein the opening in the valve stem packing is in alignment with an inner opening of emission hole.

15. A valve comprising:
a body having an inner cavity;
a ball-like element movably disposed within the inner cavity, the ball-like element configured to control a flow of fluid through the inner cavity,
wherein the body is unattached with an emission bonnet configured with one or more fugitive emission ports, and
wherein the body comprises a fugitive emission assembly as an integral component of the body.

16. The valve of claim 15, wherein the fugitive emission assembly comprises an emission hole extending within the body, the emission hole being in fluid communication with an inner chamber of the body.

17. The valve of claim 16, wherein the emission hole comprises a first emission hole, and wherein the fugitive emission assembly comprises a second emission hole extending within the body,
wherein the first and second emission holes are in fluid communication with the inner chamber at opposing portions of the inner chamber.

18. The valve of claim 16, wherein the emission hole extends within the body in a direction that is substantially perpendicular to a longitudinal axis of the cavity.

19. The valve of claim 16, wherein the valve further comprises:
a valve stem disposed within the inner chamber, the valve stem coupled to the ball-like element, wherein axial movement of the valve stem is configured to move the ball-like element between the open and closed positions; and
valve stem packing disposed around the valve stern,
wherein the emission hole is configured to receive the media from an opening in the valve stem packing.

20. The valve stem of claim 12, wherein the valve stem packing comprises a lantern ring comprising the opening in the valve stem packing, and wherein the opening in the valve stem packing is in alignment with an inner opening of the emission hole.
